(19) United States
(12) Patent Application Publication
(10) Pub. No.: US 2005/0164861 A1
(43) Pub. Date: Jul. 28, 2005

(54) Full-jacket helix centrifuge with a weir

(76) Inventors: Paul Bruning, Oelde (DE); Jurgen Hermeler, Haltern (DE); Helmut Figgener, Oelde (DE)

Correspondence Address: BARNES & THORNBURG, 750-17TH STREET NW, SUITE 900, WASHINGTON, DC, 20006, US

(21) Appl. No.: 10/502,788

(22) PCT Filed: Jan. 27, 2003
(86) PCT No.: PCT/EP03/00776

(30) Foreign Application Priority Data
Jan. 30, 2002 (DE) 102 03 652.7

(51) Int. Cl. B04B 1/20; B04B 11/02

(52) U.S. Cl. 494/56; 494/53

(57) ABSTRACT

A full-jacket helix-type centrifuge including a drum and at least one weir having a port. A throttle disk is assigned to the port. At least one nozzle rotates with the drum and is assigned to an outlet for discharging clarified liquid from the drum.

The invention relates to a full-jacket helix-type centrifuge according to the preamble of claim 1.

Such a centrifuge is known from German Patent Document DE 43 20 265 A1. The full-jacket helix-type centrifuge disclosed in document is provided with a weir on the fluid outlet side, which weir has a port which may be formed by several grooves originating from the inside diameter of the weir or by openings provided in the walls of the weir. A throttle disk, which stands still relative to the drum during the rotation of the drum and can be axially displaced by way of a threaded bush, is assigned to the port.

The distance between the weir and the throttle disk can be changed by the rotation of the threaded bush. As a result, the discharge cross-section changes for the fluid discharging from the centrifugal drum, which discharge cross-section is composed of the overall length of the overflow edge of the port and the distance between the weir and the throttle disk.

The change of the discharge cross-section causes a change of the fluid level in the centrifugal drum, so that a continuous adjustment of this liquid level becomes possible by displacing the throttle disk.

The displacing of the throttle disk in the axial direction can also be implemented in that the throttle disk is linked on its outer circumference and is swivelled, which virtually causes an axial displacement between throttle disk and the weir in the area of the weir.

The publication “Patent Abstracts of Japan”, Number 11179236 A shows that baffle plates can be assigned to a port, which provide the fluid discharging from the drum with a swirl, whereby the occurring recoil effect is to be utilized for saving energy.

The construction according to German Patent Document DE 43 20 265 A1 has been successful per se since it offers a solution to the problem occurring in the case of the construction in German Patent Document DE 41 32 029 A1 which is that the devices for adjusting the overflow diameter on the weir rotate along with the drum during the operation, which requires a relatively high-expenditure and cumbersome transfer of actuating forces to the rotating centrifugal drum.

It is nevertheless desirable to create an additional adjusting possibility of the weir of the full-jacket helix-type centrifuge to variable inflow capacities for different usage purposes by means of simple devices. The invention aims to solve this problem.

The invention achieves its task by means of the object of claim 1.

Accordingly, at least one or more nozzles rotating along with the drum is/are additionally assigned to the port for the discharge/diverting of the clarified fluid.

In this manner, the invention permits the diverting of a basic quantity from the drum through the nozzles, which quantity is fixed during the operation, and an additional precise regulating or precise adjusting of the liquid level in the full-jacket centrifuge by means of the variable throttling device, particularly the throttle disk.

Although nozzles on full-jacket centrifuges and their effect with respect to saving power when correspondingly directed in an inclined manner relative to the drum axis are known per se, thus, for example, from German Patent Document DE 39 004 151 A1, the advantageous effect resulting from the combination of these nozzles with a throttling device at the liquid discharge is not known. The throttling device is used for regulating the fluid level in the centrifuge. An increasing flow resistance at the gap through which the fluid exits at the throttling device requires a higher fluid pressure at the port which results in a rise of the fluid level in the centrifuge. Since, as a result of this pressure change, the amount of the fluid quantity flowing out through the nozzles also changes, these two effects add up; that is, the achievable control range becomes larger and the control characteristic is advantageously influenced. This effect does not occur according to the state of the art, since no throttling device with nozzles connected on the input side is provided there, but only nozzles with an overflow opening on the output side. According to the state of the art, it is hoped that, as a result of the nozzle, power will be saved and the conditions at the solids discharge will be improved.

In a particularly advantageous manner, the nozzles are constructed to be changeable in order to be able to carry out a preadjustment of the discharging fluid amount in a simple manner; for example, in the event of strongly varying amounts of throughput. It is another advantage of this measure that the exchange of the nozzles for other nozzles with a different diameter provides a simple additional possibility of changing the control characteristic and adjusting characteristic. “Nozzles” with blind holes (closed holes) can also be used, whereby the number of nozzles and the characteristic can also be changed.

In this case, the nozzles are preferably connected behind the port, and the throttling device, in turn, is connected behind the nozzles.

Preferably, the nozzle chamber also has a diameter which corresponds to the diameter the outer edge of the port. As a result, very favorable flow conditions are ensured in the nozzle chamber which largely or completely prevent an accumulation of dirt. Particularly also in the case of this variant, broaching elements are no longer required in the nozzle chamber.

In order to avoid clogging, it is advantageous for the nozzles to have a diameter of more than 2 mm. In particular, the nozzles can be provided with such a large diameter if, relative to the lagging, they are arranged radially offset toward the interior, specifically preferably such that, in a plane perpendicular to the drum axis, the nozzles have a distance of from 25 to 75% of the drum radius from the outer drum radius. Their diameter can be selected to be the larger, the farther the nozzles are arranged toward the interior, in order to implement a consistent discharge output. The arrangement farther toward the interior, basically allows the nozzles to be designed such that clogging is reliably avoided. This was not recognized in the state of the art. Also for this reason, the nozzles have not been significantly successful in practice.

Another advantage of the measure of arranging the nozzles farther in the interior toward the axis of rotation is that it becomes possible to change the ring chamber provided according to German Patent Document DE 43 20 265 A1—called ring duct there—such that the broaching tools provided and arranged there in the ring duct, which are necessary for avoiding the accumulation of dirt, can be eliminated.

In addition to the good adjustability and adaptability of the amount of the discharging fluid from the full-jacket helix-type centrifuge, it is another advantage that, when the openings of the nozzles are directed correspondingly inclined with respect to the axis of symmetry, the fluid exiting from the nozzles reduces the driving power and energy of the full-jacket helix-type centrifuge to be applied. This saving of energy is not inconsiderable and can lead to a noticeable lowering of the power consumption of the full-jacket helix-type centrifuge.

Relative to the rotating direction of the drum, the openings of the nozzles are preferably directed to the rear in order to save energy.

Relative to a tangent in a plane perpendicular to the axis of rotation on the drum surface, the openings of the nozzles are preferably directed such that they have an inclination of between 0° and 30°. An inclination of 0° results in a maximal gain of energy. Values larger than 0° and smaller than 30° can easily be implemented constructively.

If a variant with a radial alignment of the nozzle openings is implemented, the advantage of the saving of energy during the actuating of the drum is eliminated. However, the easy adaptability to different amounts passing through is maintained, so that such a variant offers a considerable advantage in comparison to the state of the art.

The gain of energy in the case of full-jacket helix-type centrifuges with such a design is so large that the circumferential speed of the drum at the outside diameter of the drum during the operation is more than 70 m/s because the gain of energy has a particularly clear effect in the case of such centrifuges.

Other advantageous further developments are contained in the additional subclaims.

In the following, the invention will be described in detail with respect to the drawing.

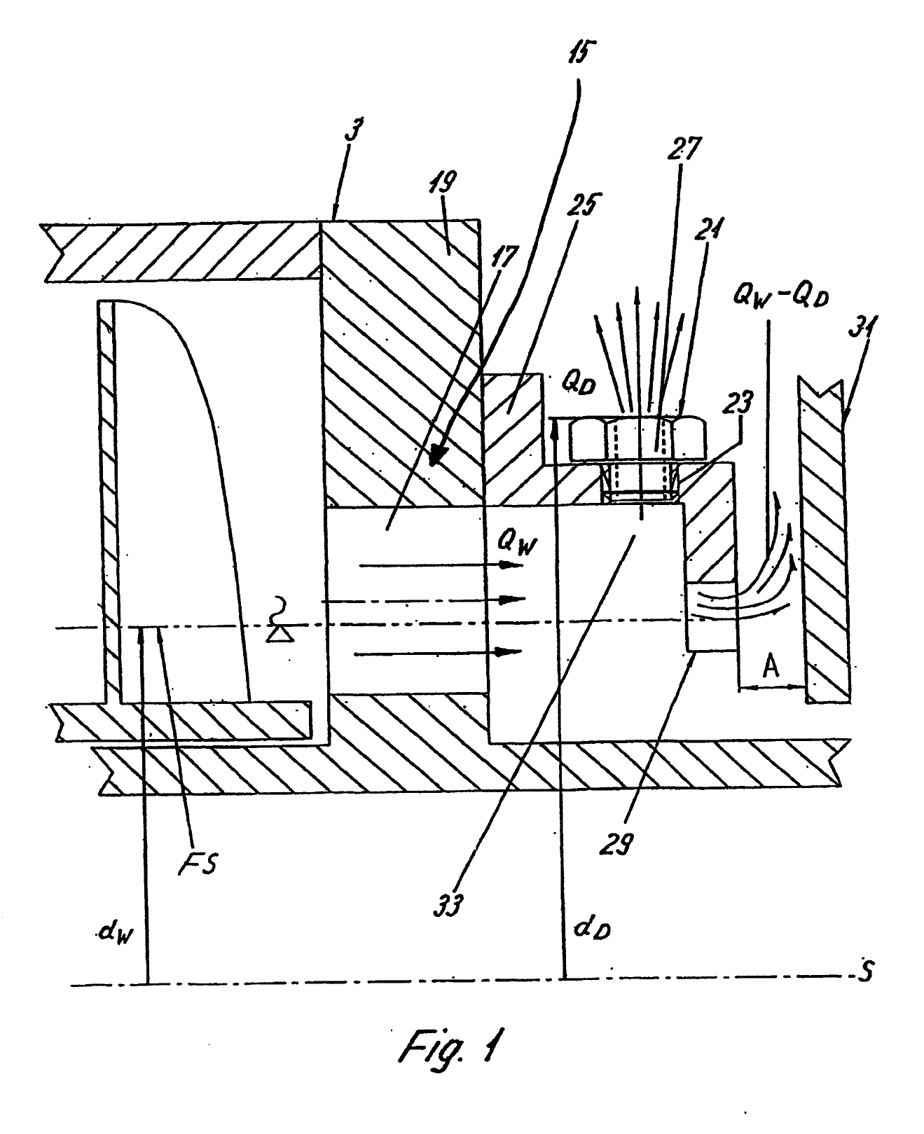

FIG. 1 is a view of the area of the weir of a full-jacket helix-type centrifuge according to the invention;

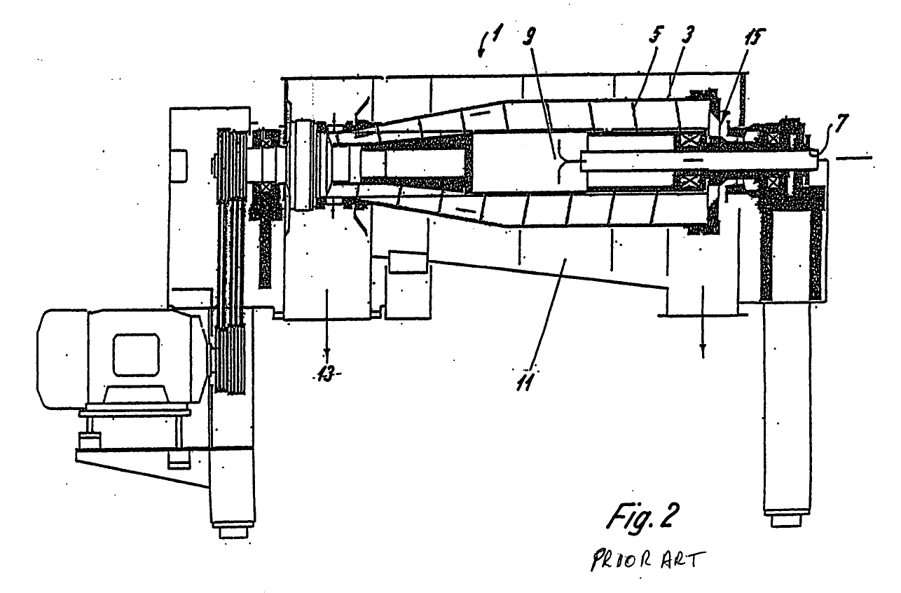

FIG. 2 is a schematic view of a known full-jacket helix-type centrifuge with a weir further developed as an overflow; and

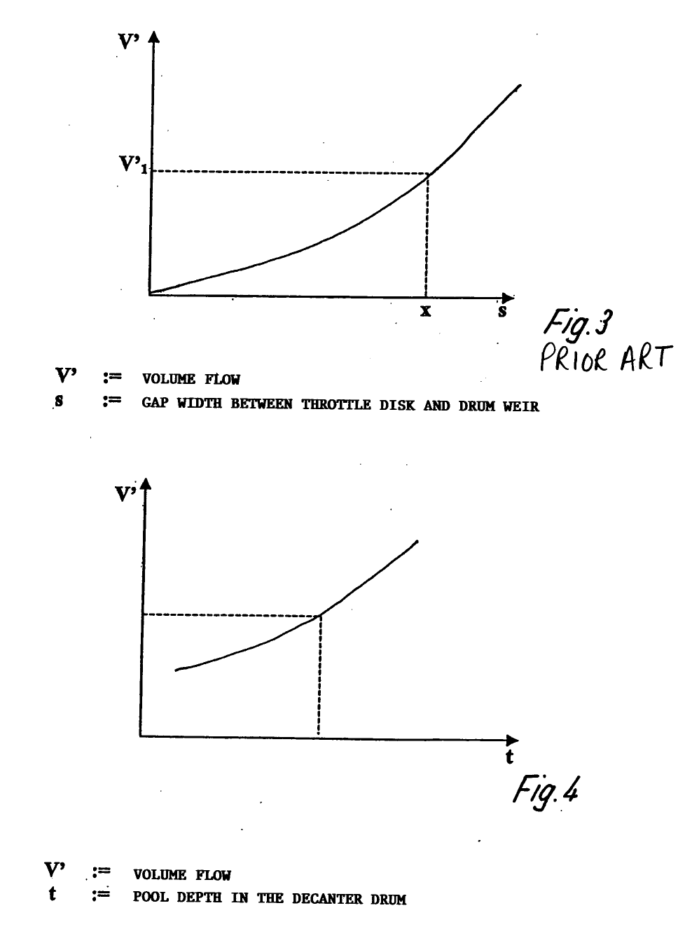

FIGS. 3 and 4 are diagrams for illustrating effects of the state of the art and of the invention.

FIG. 2 has the purpose of illustrating the basic construction of a full-jacket helix-type centrifuge.

FIG. 2 shows a full-jacket helix-type centrifuge 1 having a drum 3 in which a helix 5 is arranged. The drum 3 and the helix 5 each have an essentially cylindrical section and a section which tapers conically here.

An axially extending centric inflow tube 7 is used for feeding the material to be centrifuged by way of a distributor 9 into the centrifugal space 11 between the helix 5 and the drum 3.

If, for example, a sludgy mush is guided into the centrifuge, coarser solid particles are deposited on the drum wall. A fluid phase is formed farther toward the interior.

The helix 5 rotates at a slightly lower or higher speed than the drum 3 and delivers the centrifuged solids toward the conical section out of the drum 3 to the solids discharge 13. In contrast, the fluid flows to the larger drum diameter at the rearward end of the cylindrical section of the drum 3 is diverted there through or by way of a weir 15.

FIG. 1 illustrates how such a weir 15 can be further developed according to the invention.

According to FIG. 1, the weir 15 has a port 17 in an axial lid 19 of the drum 3 to which a combination of at least one or more nozzles 21 as well as an adjustable throttling device is assigned—here, connected on the output side—.

The nozzles 21 are constructed as screwing bodies inserted into directed openings 23 of a stepped ring attachment 25, which openings 23 are further developed radially or inclined with respect to the drum axis, the holes or openings 27 of the screwing bodies being aligned perpendicularly or at an angle with respect to the drum axis S of the drum.

In the area or section adjoining the port 17, the ring attachment 25 has an inside diameter which corresponds to the outside diameter of the port 17. The nozzle chamber 33 also has a diameter which corresponds to the diameter at the outer edge of the port 17. Also, the inlet openings 27 of the nozzles are preferably situated flush with the diameter of the overflow-type port 17. This prevents the accumulation of dirt in the nozzle chamber 33.

At its end facing away from the port 21, the ring attachment 25 forms an axial outlet 29 on whose output side the throttle disk 31 is connected whose distance from the outlet 29 is variable, for example, in the manners described in German Patent Document DE 43 20 265 A1 by means of different actuating devices (not shown here).

The distance between the throttle disk 31 and the outlet 29 is preferably changed an the axial moving, particularly by an axial displacing (can also be implemented by a swivelling) of the throttle disk 31 which stands still relative to the rotating drum 3. As an alternative, it is also conceivable that the throttle disk 31 rotates along with the drum 3 in the operation (not shown). However, this solution requires higher constructive expenditures than the variant which does not rotate along.

The term “nozzle” is to be understood such that the bore 27 may have a diameter which is constant or variable along the axial dimension of the opening. The nozzle 21 may also be constructed as a bore in the ring attachment 25; however, the screwing bodies offer the advantage of the changeability and thus of the preadjustment of the discharge quantity.

In the inner nozzle chamber 33, ribs (not shown here) may improve the delivery.

Through the nozzles 21, a basic quantity of fluid preadjusted depending on the design and diameter of the openings of the changeable screwing bodies is diverted from the drum 3. The optimal alignment of the nozzles 21 for a maximal saving of energy can be determined by simple tests.

For example, in the case of a full-jacket helix-type centrifuge for thickening a sludge at the ratio of 1:10 with an inflow capacity of 300 m3/h and a removal of solids of 30 m3/h, a nozzle design for 200 m3/h as well as a diversion of 70 m3/h is recommendable for regulating the level by way of the throttle disk 31.

When lower capacities of, for example, 200 m3/h inflow are implemented, a quantities of solids of, for example, 20 m3/h is obtained. In the case of this quantity, a nozzle design for 110 m3/h as well as again a diversion of 70 m3/h would be recommendable for regulating the level by way of the throttle disk 31.

For an adaptation to different capacities, the nozzles 21 are therefore simply exchanged for those of a different diameter. A high-expenditure exchange of expensive and complicated components is not required.

The nozzles 21 are preferably arranged in a plane perpendicular to the drum axis at a distance from the outer drum radius or circumference of from 25 to 75% of the drum radius, because the gain of energy is the larger, the closer the nozzles 21 are to the drum circumference. However, an arrangement farther toward the interior has the advantage that the diameter of the nozzles or their opening cross-section may be larger than in the case of an arrangement farther toward the outside, so that they clog less rapidly. The above-mentioned range represents a good compromise between the above-mentioned effects.

As in German Patent Document DE 43 20 265 A1, a change of the discharge cross-section by adjusting the distance between the throttle disk 31 and the outlet 29 causes a change of the fluid level in the drum 3. In this case, particularly the fluid level FS in the full-jacket helix-type centrifuge is precisely adjusted by means of the throttle disk 31.

The following applies in the case of the full-jacket helix-type centrifuge of FIG. 2 to the discharging particle flow Q_{w} by way of the weir 15 with a diameter d_{w}, the circumferential speed U_{w} at the weir diameter d_{w} amounting to:
P(Q_{w})=p×Q_{w}×U²_{w}.

In contrast, in the case of the invention, the largest portion of the volume flow at the diameter d_{w} is diverted through the nozzles (volume flow Q_{D}), and another partial flow is diverted through the outlet 29 of a throttle disk 31.

If, as a result of the throttle disk 31, the fluid level in the chamber is held at the weir diameter d_{w}, the capacity as a result of the throughput fraction Q_{D} flowing off from the nozzles 21 amounts to
P(Q_{D})=p×Q_{D}×U²_{w}×A.

In the case of a nozzle inclination angle between 0 and 30°, a clear power demand reduction is computed from this formula. A is a function of the diameter and of the shape of the cross-section of the nozzle 21, of the level in the drum and of the emission angle of the nozzle jet. The geometry of the cross-sections of the nozzles 21 may have an arbitrary design; thus, it may be round or square or of a different shape.

FIG. 3 shows the conditions in the case of a construction of the type of German Patent Document DE 43 20 265 A1 without nozzles. The gap width s between the throttle disk 31 and the drum weir outlet 17 is entered on the X-axis; the volume flow V′ is entered on the Y-axis. For a gap width X, a volume flow V1′ is thereby obtained. The larger the gap width S, the larger the volume flow which is diverted between the throttle disk 31 and the drum weir 17 out of the drum 3. Inversely, the volume flow becomes the larger, the narrower the gap width is adjusted between the throttle disk 31 and the drum weir. Simultaneously, the pool depth rises within the decanter drum; that is, the surface level moved further toward the interior as the gap decreases.

In contrast, FIG. 4 shows the behavior of the volume flow V′ at the nozzles 21. Here, the volume flow rises with an increasing pool depth as a result of the pressure at the nozzle inflow present in the fluid. Both effects are mutually superimposed. In practice, this increases the control range at the decanter of the type of FIG. 1 to twice the amount in comparison to a decanter without nozzles 21 of the type of FIG. 3.

1. A full-jacket helix-type centrifuge, comprising:
a drum;
at least one weir having a port;
a throttle disk assigned to the port, the throttle disk being located at a variable distance from the port; and
at least one nozzle rotating with the drum, the at least one nozzle assigned to an outlet for discharging clarified liquid from the drum.

2. The full-jacket helix-type centrifuge according to claim 1, wherein, in a plane perpendicular to a drum axis, the at least one nozzle is located at a distance from an outer drum radius, the distance being 25 to 75% of the outer drum radius.

3. The full-jacket helix-type centrifuge according to claim 1, wherein the at least one nozzle has a diameter of more than two millimeters.

4. The full-jacket helix-type centrifuge according to claim 1, wherein the at least one nozzle is connected behind the port and the throttling device is, connected behind the at least one nozzle.

5. The full-jacket helix-type centrifuge according to claim 1, wherein the at least one nozzle is configured to be changeable.

6. The full-jacket helix-type centrifuge according to claim 5, wherein the at least one nozzle is configured to include a screwing body.

7. The full-jacket helix-type centrifuge according to claim 1, wherein the at least one nozzle includes a plurality of nozzles distributed on a drum lid of the drum.

8. The full-jacket helix-type centrifuge according to claim 6, wherein the at least one screwing body is screwed into at least one opening of a ring attachment at a lid of the drum.

9. The full-jacket helix-type centrifuge according to claim 1, wherein the at least one nozzle is arranged in a nozzle chamber formed by a ring attachment, and an inside diameter of the nozzle chamber corresponds to an outside diameter of the port.

10. The full-jacket helix-type centrifuge according to claim 1, wherein an inlet opening of the at least one nozzle is arranged flush with the an inside diameter of a nozzle chamber formed by a ring attachment.

11. The full-jacket helix-type centrifuge according to claim 1, wherein an inlet opening of the at least one nozzle is aligned at an angle with respect to an axis of rotation (of the drums.

12. The full-jacket helix-type centrifuge according to claim 1, wherein an opening of the at least one nozzle is directed backwards relative to a rotating direction of the drum.

13. The full-jacket helix-type centrifuge according to claim 1, wherein an inlet opening of the at least one nozzle, relative to a tangent to a drum surface in a plane perpendicular to Van axis of rotation of the drum, has an inclination of between zero and 30°.

14. The full-jacket helix-type centrifuge according to claim 1, wherein, relative to an outer wall of the drum, an opening of the at least one nozzle is directed radially toward Ran outside of the drum.

15. The full-jacket helix-type centrifuge according to claim 1, further including a ring attachment including an outlet its end facing away from the port, and the throttle disk being located at an output side of the outlet.

16. The full-jacket helix-type centrifuge according to claim 1, wherein a distance between the throttle disk and an outlet is variable by an axial displacing, of the throttle disk.

17. The full-jacket helix-type centrifuge according to claim 1, wherein a circumferential speed of the drum at an outer diameter of the drum during an operation is more than 70 m/s.

18. The full-jacket helix-type centrifuge according to claim 1, wherein the throttle disk is constructed so as to stand still relative to the drum during an operation of the centrifuge.

19. The full-jacket helix-type centrifuge according to claim 1, wherein the throttle disk is constructed so as to rotate along with the drum during an operation of the centrifuge.

20. The full-jacket helix-type centrifuge according to claim 1, wherein the at least one nozzle includes a plurality of nozzles distributed on a component attached to a drum lid.

21. The full-jacket helix-type centrifuge according to claim 7, wherein the plurality of nozzles are configured to include screwing bodies, and the screwing bodies are screwed into openings of a ring attachment at the lid of the drum.

22. The full-jacket helix-type centrifuge according to claim 9, wherein inlet openings of the at least one nozzle are arranged flush with the inside diameter of the nozzle chamber.
